(19) United States
(12) Patent Application Publication
(10) Pub. No.: US 2005/0216318 A1
(43) Pub. Date: Sep. 29, 2005

(54) System and method for travel planning

(76) Inventor: Christine Gray, Portland, ME (US)

Correspondence Address: LAW OFFICE OF BRETT N. DORNY, 321 CHURCH STREET, NORTHBOROUGH, MA, 01532, US

(21) Appl. No.: 10/813,193

(22) Filed: Mar. 29, 2004

(51) Int. Cl. G06F 17/60

(52) U.S. Cl. 705/6

(57) ABSTRACT

A computerized system for determining lodging options for travelers. The system includes a database of lodging options including information regarding the type of experience the traveler can expect at each option. The system allows searching of the database according to various criteria, including the experience information.

### BACKGROUND OF THE INVENTION

1. Field of the Invention

The present invention relates to a computer based system for travel planning and making travel reservations. More particularly, it relates to a system and method for locating lodging according to desired types of locations.

2. Discussion of Related Art

Traditionally, people planning vacation or travel would visit a travel agent to select locations and make reservations. The traveler would select a location and the agent would then provide the traveler with various options for lodging. Generally, the lodging options were limited to those known to the travel agent. Often, various location would provide brochures or other types of information regarding the lodging options, or the travel agents would collect information about lodging options from other agents. However, the knowledge of a particular agent regarding the lodging options was somewhat limited. However, the travel agent would generally have significant knowledge of the attributes of the various lodging options to be recommended. Thus, an agent could assist a traveler in selecting the lodging which would provide the traveler with a desired type of experience. The experience would depend upon the type of facility, the siting of the facility, and the amenities of the facility and surrounding area.

As computers became more common, information regarding lodging options were stored in files and databases for access by agents or travelers. With the advent of the Internet and other global computer networks, numerous options exist for travelers to obtain information regarding lodging, typically without the use of a travel agent. However, the available information and database generally require a traveler to designate a specific geographic location, often a particular city, in order to obtain specific information on lodging options. Nevertheless, many travelers do not have a specific destination preferences. Instead, they prefer a particular type of experience. For example, a traveler may desire beachfront property in Italy, but the specific city or beach is not important. The traveler, or an agent working with a traveler, cannot easily access computerized information with respect to lodging which meets the users criteria.

### SUMMARY OF THE INVENTION

The present invention provides a computerized system for storing and retrieving lodging information in an manner useful to travelers. In particular, according to an aspect of the invention, information regarding lodging options is stored in a database. The database includes information relating to the geographic location, the type of facility, and the nature of experiences. A searching function allows users of the system to search the database according to any of the types of information. According to an aspect of the invention, the user can search according to the type of experience for a lodging facility. According to another aspect of the invention, the database is connected to a global network. Users may access the database and use the searching function from computers attached to the global network. According to another aspect of the invention, the system can be used to make reservations for desired lodging.

The present invention includes a method for searching lodging information. The method includes steps for searching lodging information based upon a desired type of experience. The type of experience may be based upon the location, type of facility, or surrounding area.

### BRIEF DESCRIPTION OF THE DRAWINGS

FIG. 1 illustrates a computer system for implementation of an embodiment of the present invention.

FIG. 2 illustrates the contents of a database according to an embodiment of the present invention.

FIG. 3 is a block flow diagram of operation of an embodiment of the present invention.

FIG. 4 illustrates a user interface for searching according to an embodiment of the present invention.

### DETAILED DESCRIPTION

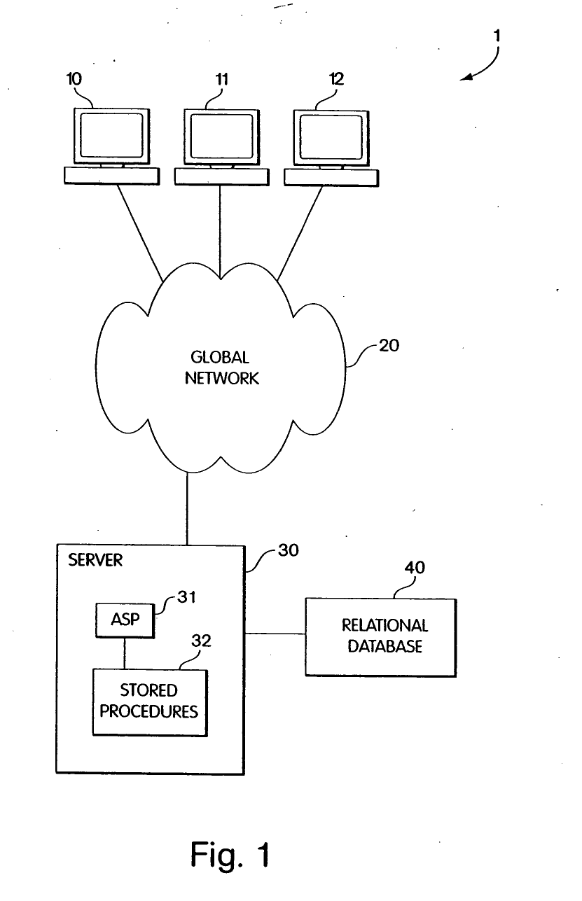

As illustrated in FIG. 1, the present invention is a system 1 which provides a process for searching lodging options according to various criteria. The system is remotely accessed through web pages on a global network 20, such as the Internet. User computers 10, 11, 12 are used to access web pages and information stored on a server 30. The system includes software running on the server 30. The software may be implemented using Microsoft SQL Server stored procedures 32 for performing the various actions required by the system. The users access the procedures through Active Server Pages (ASP) 31 implemented using VB script. The server accesses a relational database 40, which can be stored in the server or a separate storage device. FIG. 2 illustrates the contents the relational database 40. Of course, other types of software implementations could be used. For example, the system could be set up for direct access by users in a local area network or a standalone system. The software could be created using other languages or programs, as necessary, depending upon the system upon which it is operating. Additionally, the relational database 40 could include a greater or fewer number of elements or could be organized differently. Those of ordinary skill in the art will easily recognize the manner in which the procedures of the present invention can be implemented in various manners other than the particular described embodiment.

The system of the present invention allows users to search and select lodging options according to various criteria. As illustrated in FIG. 2, the database 40 includes a record 100 for each lodging option. FIG. 2 illustrates the contents of a record 100 for one lodging option stored in the database 40. With respect to each lodging option in the database 40, the record 100 includes facility information 110, destination designators 120, experience designators 130, accommodation designators 140, special offer designators 150, web page or website information 160, and reservation information.

Facility information 110 may include an address, telephone numbers, email addresses, numbers of rooms, or other information regarding the facility. The facility information 110 would generally include all information typically provided in a brochure or listing for the facility.

The destination designators 120, experience designators 130, accommodation designators 140, and special offer designators 150 are used for searching the database to locate lodging options which meet the desires of the system user. Designators may be stored as words, codes or other representations of the information designated. According to an embodiment of the present invention, the a predetermined set of choices are identified for each of the designators. The choices are used both in storing information about a lodging option in the database and for later searching. Destination designators 120 may include parts of the world, such as continents, geographic areas, hemispheres, etc., specific countries, parts of countries, individual cities, or parts of cities. The accommodation designators 140 represent the type of facility, such as hotel, bed & breakfast, lodge, inn, resort, luxury train, island, villa, yacht, etc. The special offer designators 150 represent special opportunities offered by the facility, such as golf packages, romance package, weekend getaways, family rates, etc.

The system of the present invention provides information similar to that previously used by travel agents to recommend locations and lodging to travelers. The experience designators 130 represent a type of experience the traveler can expect at the lodging. For example, an experience designator 130 for an ocean or island experience may be used with beach front property, ocean views, or island locations. Other designators can be used for mountain hideaways, castles, country inns, adventure or eco-trip locations, city or cultural locations, gourmet and wine areas, active or sporting activities, etc.

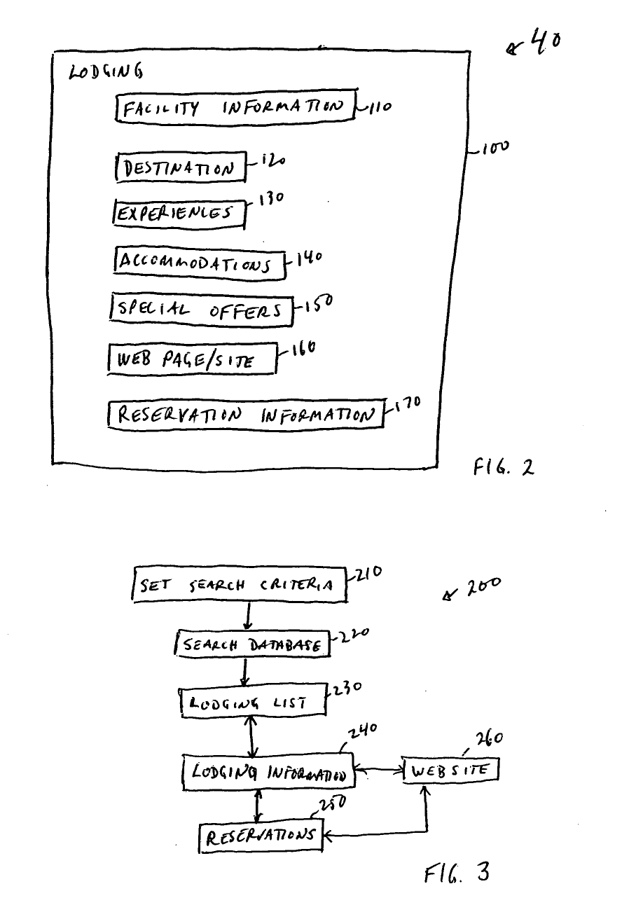

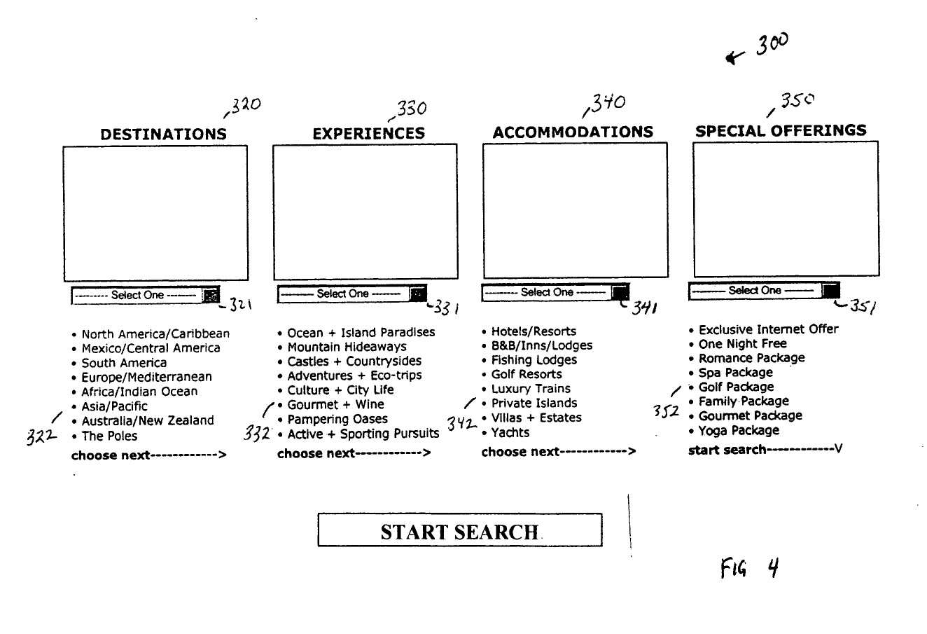

FIG. 3 represents a program flow 200 for the system according to an embodiment of the present invention. At step 210, the user selects a set of search criteria. FIG. 4 illustrates a user interface 300 for selecting search criteria. The user interface 300 includes a set of drop-down menus 321, 331, 341, 351 corresponding to the destination designators 320, experience designators 330, accommodation designators 340, and special offer designators 350. Examples of the possible choices 322, 332, 342, 352 are set forth below the drop-down menus 321, 331, 341, 351. The user may select one or more item from each drop-down menu 321, 331, 341, 351, using known processes. Selection of items from the drop-down menus 321, 331, 341, 351 sets the search criteria at step 210 of FIG. 3. The selected search criteria are used to search the database 40 at step 220. All lodging options which include designators corresponding to the selected search criteria are retrieved. The system then displays a list of lodging options (step 230) which meet the search criteria. The list may include the name, address, location, or other information regarding each lodging option. The list may be organized based upon a preselected form or may be randomly identified.

The system allows the user to select items from the lodging list to obtain more information about that option. The amount, type and format of the additional information may be set to be uniform for all lodging options or may vary from option to option. The additional information may include the facility information 110. It may also include links to a web page or website 160 for the facility. Alternatively, the additional information may merely present the website or web page for the facility. Each lodging option may have a web page stored in the database which can then be used to access a separate website, at step 260. The additional information may also include an online process for checking availability or making reservations for a lodging option (step 250). The reservation process may be implemented with the system of the present invention or the system may access another existing reservation process.

The system of the present invention allows a user to locate lodging options in a manner similar to that previously available from travel agents. The user may designate a specific type of desired experience, such as beach or city. The system can retrieve lodging options at different locations throughout the world which provide those types of experiences. The user may further limit the options to various parts of the world, types of accommodations, and/or special offers. Travel agents may also use the system to locate lodging options for travelers of which the travel agent is not personally aware. The system still allows the travel agent to locate a lodging option which meets the desired experience of the user.

Having described at least one embodiment of the present invention, adaptations, modifications, additions, and variations will be readily apparent to those of skill in the art. Such adaptations, modifications, additions and variations are considered part of the present invention which is not limited expect with respect to the claims hereto.

1. A system for determining lodging options, the system comprising:
a database of a plurality of lodging options, wherein the database includes at least one experience designator for each lodging option;
an experience input for receiving at least one desired experience designator; and
means for generating and displaying a list of lodging options which include the at least one desired experience designator.

2. The system for determining lodging options according to claim 1, wherein the at least one experience designator represents a type of experience associated with a particular lodging option.

3. The system for determining lodging options according to claim 1, further comprising:
a lodging selection input for selecting a lodging option from the list of lodging options; and
means for displaying additional information for a selected lodging option.

4. The system for determining lodging options according to claim 3, wherein the additional information is retrieved from the database.

5. The system for determining lodging options according to claim 3, wherein the additional information is retrieved from a storage location other than the database.

6. The system for determining lodging options according to claim 3, further comprising:
means for making a reservation at the selected lodging option.

7. The system for determining lodging options according to claim 1, wherein the database further includes at least one destination designator for each lodging option, each destination designator representing a geographic location of the lodging option; and
wherein the system further includes:
a destination input for receiving at least one desired destination designator; and
means for generating and displaying a list of lodging options which inlude the at least one desired destination designator.

8. The system for determining lodging options according to claim 1, wherein the database further includes at least one accommodation designator for each lodging option, each accommodation designator representing a type of facility of the lodging option; and
wherein the system further includes:
a accommodation input for receiving at least one desired accommodation designator; and
means for generating and displaying a list of lodging options which inlude the at least one desired accommodation designator.

9. The system for determining lodging options according to claim 1, wherein the database further includes at least one special offering designator for each lodging option, each special offering designator representing a special offer available at the lodging option; and
wherein the system further includes:
a special offering input for receiving at least one desired special offering designator; and
means for generating and displaying a list of lodging options which inlude the at least one desired special offering designator.

10. A method for locating lodging options stored in a database, the method including the steps of:
inputting type of experience associated with a lodging option;
searching a database of lodging options for lodging options which include the inputted type of experience; and
displaying a listing of lodging options retrieved by the searching step.

11. The method for locating lodging options according to claim 10, further comprising the steps of:
selecting a lodging option from the displayed list; and
displaying additional information regarding the selected lodging option.

12. The method for locating lodging options according to claim 11, further including the step of retrieving the additional information from a storage location other than the database.

13. The method for locating lodging options according to claim 11, further including the step of retrieving the additional information from the database.

14. The method for locating lodging options according to claim 11, further comprising the step of:
making a reservation for the selected lodging option.
